(19) United States
(12) Patent Application Publication
(10) Pub. No.: US 2026/0333099 A1
(43) Pub. Date: Oct. 22, 2026

(54) GENERATION OF A FEEDBACK REPORT BASED ON DOWNLINK CONTROL INFORMATION

(71) Applicant: Lenovo (United States) Inc., Morrisville, NC (US)

(72) Inventors: Joachim Löhr, Wiesbaden (DE); Alexander Golitschek Edler von Elbwart, Darmstadt (DE); Prateek Basu Mallick, Dreieich (DE)

(73) Assignee: Lenovo (United States) Inc., Morrisville, NC (US)

(21) Appl. No.: 19/462,889

(22) Filed: Jan. 28, 2026

(51) Int. Cl. H04W 24/10; H04L 1/1812; H04W 72/232

(52) U.S. Cl. CPC H04W 24/10; H04L 1/1812; H04W 72/232

(57) ABSTRACT

Various aspects of the present disclosure relate to the generation of a feedback report based on downlink control information (DCI). An apparatus, such as a user equipment (UE), receives, from a network equipment (NE), DCI that indicates transmission of a transport block (TB) and indicates a hybrid automatic repeat request (HARQ) process associated with the transmission. Based on the DCI, the UE triggers generation of a feedback report associated with the TB and the HARQ process, and the UE starts a timer based on triggering the generation of the feedback report. If the UE determines that one or more resources are available for transmission of the feedback report while the timer is running, the UE generates the feedback report and transmits the feedback report to the NE on the one or more resources.

### TECHNICAL FIELD

The present disclosure relates to wireless communications, and more specifically to the generation of a feedback report based on downlink control information (DCI).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive DCI that indicates transmission of a transport block (TB) and indicates a hybrid automatic repeat request (HARQ) process associated with the transmission, trigger, based on the DCI, generation of a feedback report associated with the TB and the HARQ process, and start a timer based on triggering the generation of the feedback report.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI that indicates transmission of a TB and indicates a HARQ process associated with the transmission, trigger, based on the DCI, generation of a feedback report associated with the TB and the HARQ process, and start a timer based on triggering the generation of the feedback report.

A method performed or performable by a UE for wireless communication is described. The method may include receiving DCI that indicates transmission of a TB and indicates a HARQ process associated with the transmission, triggering, based on the DCI, generation of a feedback report associated with the TB and the HARQ process, and starting a timer based on triggering the generation of the feedback report.

In some implementations of the UE, the processor, and the method described herein, the UE, the processor, and the method may further be configured to, capable of, or operable to determine, while the timer is running, that one or more resources are available for transmission of the feedback report, generate the feedback report based on determining that the one or more resources are available, and transmit the feedback report on the one or more resources. In some implementations, to generate the feedback report, the UE, the processor, and the method may further be configured to, capable of, or operable to generate a medium access control (MAC) control element (MAC-CE) and transmit the MAC-CE on the one or more resources. In some implementations, the feedback report is included in the MAC-CE and includes HARQ feedback for one or more HARQ processes, and the one or more HARQ processes include the HARQ process associated with the transmission of the TB. In some implementations, the UE, the processor, and the method may further be configured to, capable of, or operable to stop the timer based on transmission of the MAC-CE.

In some implementations, the UE, the processor, and the method may further be configured to, capable of, or operable to receive, based on incorrect reception of the transmission of the TB, second DCI that indicates transmission of a second TB and indicates the HARQ process associated with the transmission of the second TB, and trigger, based on the second DCI, generation of a second feedback report associated with the second TB and the HARQ process, where the second feedback report includes a HARQ feedback error indication. In some implementations, the UE, the processor, and the method may further be configured to, capable of, or operable to start a second timer based on triggering the generation of the second feedback report. In some implementations, the feedback report includes HARQ feedback that indicates whether the UE correctly decoded the TB. In some implementations, the feedback report includes assistance information for scheduling subsequent downlink transmission, where the assistance information includes one or more of a modulation and coding scheme (MCS), a redundancy version (RV), or an amount of incremental redundancy. In some implementations, the feedback report includes an identifier (ID) associated with the HARQ process. In some implementations, the UE, the processor, and the method may further be configured to, capable of, or operable to cancel the feedback report based on an expiration of the timer.

An NE (e.g., a base station, a gNB) for wireless communication is described. The NE may be configured to, capable of, or operable to perform one or more operations as described herein. For example, the NE may be configured to, capable of, or operable to transmit DCI that indicates transmission of a TB and indicates a HARQ process associated with the transmission, where the DCI triggers generation of a feedback report associated with the TB and the HARQ process.

A processor (e.g., a standalone processor chipset, or a component of an NE) for wireless communication is described. The processor may be configured to, capable of, or operable to perform one or more operations as described herein. For example, the processor may be configured to, capable of, or operable to transmit DCI that indicates transmission of a TB and indicates a HARQ process associated with the transmission, where the DCI triggers generation of a feedback report associated with the TB and the HARQ process.

A method performed or performable by an NE (e.g., a base station) for wireless communication is described. The method may include transmitting DCI that indicates transmission of a TB and indicates a HARQ process associated with the transmission, where the DCI triggers generation of a feedback report associated with the TB and the HARQ process.

In some implementations of the NE, the processor, and the method described herein, a timer is started based on the generation of the feedback report being triggered, and the NE, the processor, and the method may further be configured to, capable of, or operable to receive the feedback report associated with the TB and the HARQ process based on one or more resources being available for transmission of the feedback report while the timer is running. In some implementations, the NE, the processor, and the method may further be configured to, capable of, or operable to receive a MAC-CE on the one or more resources, where the MAC-CE includes the feedback report. In some implementations, the feedback report is included in the MAC-CE and includes HARQ feedback for one or more HARQ processes, and the one or more HARQ processes include the HARQ process associated with the transmission of the TB. In some implementations, the timer is stopped based on transmission of the MAC-CE.

In some implementations, the NE, the processor, and the method may further be configured to, capable of, or operable to transmit, based on incorrect reception of the transmission of the TB by a UE, second DCI that indicates transmission of a second TB and indicates the HARQ process associated with the transmission of the second TB, and receive a second feedback report associated with the second TB on one or more resources, where the second feedback report includes a HARQ feedback error indication. In some implementations, the feedback report includes an ID associated with the HARQ process.

### BRIEF DESCRIPTION OF THE DRAWINGS

FIG. 1 illustrates an example of a wireless communications system in accordance with aspects of the present disclosure.

FIGS. 2 and 3 illustrate examples of MAC-CEs in accordance with aspects of the present disclosure.

FIG. 4 illustrates an example of a signaling diagram in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, in a 5G system and other systems beyond 5G (e.g., 6G systems), the UE and the NE may communicate downlink and uplink transmissions. Such transmissions may use (e.g., employ, execute, apply) a number of HARQ processes with incremental redundancy for retransmissions in case a receiver incorrectly receives a TB (e.g., a data block). As used herein, HARQ may refer to a combination of forward error correction and automatic repeat request (ARQ) protocols that enable a receiver, such as a UE, to request retransmission of data that was not successfully decoded. A HARQ process may refer to a logical entity (e.g., implemented as electronic hardware, firmware, software, or combinations of hardware, firmware, or software within the UE) that manages the transmission and retransmission of a particular TB, with each HARQ process being identified by a HARQ process ID. For downlink transmissions, for example, the NE may expect the UE to transmit acknowledgment (ACK) or negative acknowledgment (NACK) feedback for each transmission and retransmission of a TB (e.g., a data block or a physical downlink shared channel (PDSCH) transmission), where an ACK may indicate that the UE successfully decoded the received TB and a NACK may indicate that the UE was unable to successfully decode the received TB. If the NE receives a NACK from the UE, the NE may continue by transmitting a scheduled retransmission of the TB. Alternatively, if the NE receives an ACK from the UE, the NE may use a corresponding HARQ process to transmit a new TB. In such cases, a toggled new data indicator (NDI) in DCI may inform the UE of the new TB.

However, in some cases, NACK-to-ACK errors may occur in which the NE incorrectly decodes NACK feedback transmitted by the UE as an ACK. Such errors may result in data loss, as the NE may prematurely move to a new TB without successfully transmitting the previous TB to the UE. Additionally, DCI may fail to indicate a specific resource for the HARQ feedback transmission, and configured uplink grants may be configured and indicated for any physical uplink shared channel (PUSCH) transmission, not explicitly for HARQ feedback. To support transmission of a HARQ feedback report on a PUSCH for improved reliability and reduced error (i.e., in particular, reduced NACK-to-ACK errors), the described techniques support the generation of a HARQ feedback report based on DCI.

As described herein, to reduce HARQ feedback errors and improve transmission reliability, an NE may transmit DCI to a UE that indicates transmission of a TB (e.g., a PDSCH transmission) and indicates a HARQ process associated with the transmission. Based on the DCI, the UE may trigger generation of a feedback report (e.g., a HARQ feedback report) associated with the TB and the HARQ process. The UE may start a timer based on triggering the generation of the feedback report. If the UE determines, while the timer is running, that one or more resources are available for uplink transmission of the feedback report, then the UE may generate the feedback report and transmit the feedback report to the NE on the one or more resources. In some examples, the UE may generate and transmit the feedback report via a MAC-CE (e.g., such that the feedback report is indicated as a HARQ-control element (HARQ-CE)). If the timer expires before the UE determines that resources are available for the uplink transmission of the feedback report, then the UE may cancel (e.g., skip, refrain from transmitting) the generation of the feedback report.

As described herein, the feedback report, or a HARQ-CE, may include feedback for HARQ processes the UE has not yet reported or for which the UE has generated HARQ feedback in a number of slots prior to the transmission of the HARQ-CE. In carrier aggregation scenarios, the HARQ-CE may include HARQ feedback information, such as HARQ-ACK information, for TB or PDSCH transmissions on other carriers. In some examples, if there are no uplink resources available prior to expiration of the timer, the UE may transmit a RACH transmission or an SR to obtain uplink resources. In some examples, if there are no uplink resources available prior to expiration of the timer, the UE may transmit the HARQ feedback information in a contention-based PUSCH transmission. In some other examples, if the NE fails to receive feedback from the UE prior to expiration of the timer, the NE may assume a NACK and continue with a TB retransmission.

The HARQ-CE may carry other information in addition to HARQ feedback. For example, the HARQ-CE may include one or more of a suggested MCS, a suggested RV, or an indication of an amount of incremental redundancy required for successful decoding. Additionally, or alternatively, the HARQ-CE may include suspected (e.g., inferred) NACK-to-ACK error indications or discontinuous transmission (DTX)-to-ACK error indications. If the NE determines that a NACK-to-ACK error or DTX-to-ACK error has occurred and the NE had not willingly stopped retransmission, the NE may transmit a retransmission grant for the affected HARQ process. If such a retransmission does not occur within a threshold duration (e.g., time limit) or within a threshold number of subsequent downlink schedulings, the UE may assume that the HARQ process is free or available for use.

In some examples, the UE may map an SR to the HARQ-CE and start a timer when the HARQ-CE is triggered. If the UE does not transmit the HARQ-CE before the timer expires, the UE may discard a pending HARQ-CE. In some examples, the HARQ-CE may include a HARQ feedback error indication, in some cases, together with HARQ feedback. In such cases, the UE may start a second timer in response to generation of a second HARQ-CE including the HARQ feedback error indication. The UE may indicate the HARQ feedback (e.g., ACK/NACK) and the HARQ feedback error indication using a single MAC-CE or in two respective MAC-CEs.

By performing the described techniques, a device (e.g., a UE and/or an NE) in a wireless communications system may provide for improved HARQ feedback transmission reliability, reduced NACK-to-ACK errors, and enhanced resource management for uplink transmissions. For example, the timer-based approach to feedback report generation, described herein, may improve resource utilization by allowing the UE to determine, while the timer is running, whether one or more uplink resources, (e.g., PUSCH resources), are available for transmission of the feedback report, and to generate and transmit the feedback report when such resources become available. Additionally, the techniques may support transmission of the feedback report via a MAC-CE, which may include HARQ feedback for one or more HARQ processes, enabling efficient multiplexing of feedback information and improved reliability compared to other feedback mechanisms. The timer may be stopped based on transmission of the MAC-CE, providing clear state management for the feedback process. Furthermore, the feedback report may include assistance information for scheduling subsequent downlink transmissions, which may enable the NE to optimize retransmission parameters. The described techniques may also support cancellation of a triggered and pending feedback report based on expiration of the timer, preventing stale feedback from being transmitted and improving overall system efficiency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

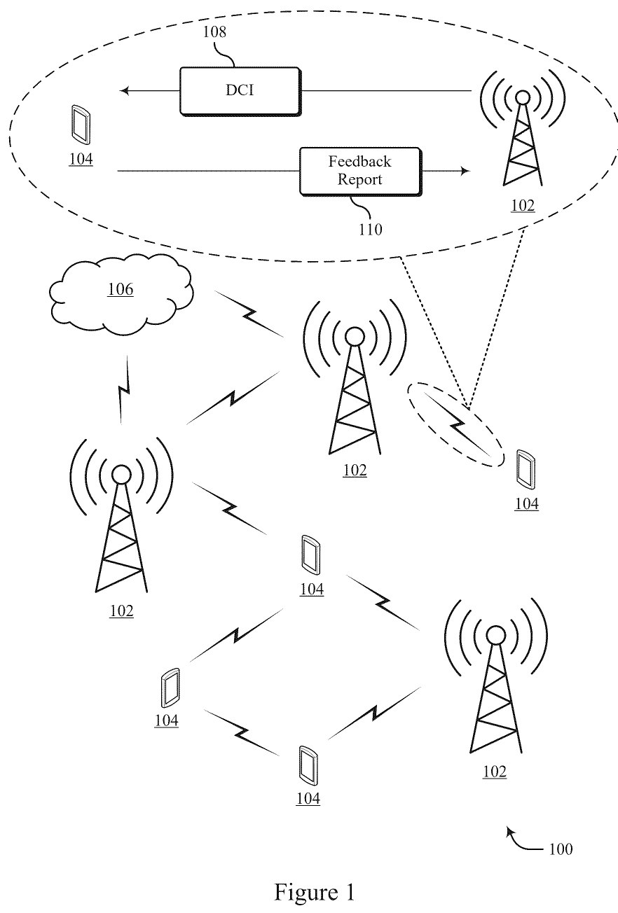

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10-millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high-data-rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least two numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, an NE 102 may transmit DCI 108 to a UE 104 that indicates transmission of a TB (e.g., a PDSCH) and indicates a HARQ process associated with the transmission. Based on the DCI, the UE 104 may trigger generation of a feedback report 110 (e.g., a HARQ feedback report) associated with the TB and the HARQ process. The UE 104 may start a timer based on triggering the generation of the feedback report 110. If the UE 104 determines, while the timer is running, that one or more resources are available for uplink transmission of the feedback report 110, then the UE 104 may generate the feedback report 110 and transmit the feedback report 110 to the NE 102 on the one or more resources. In some examples, the UE 104 may generate and transmit the feedback report 110 via a MAC-CE (e.g., such that the feedback report 110 is indicated as a HARQ-CE). If the timer expires before the transmission of the feedback report 110, then the UE 104 may cancel (e.g., skip, refrain from transmitting) the triggered feedback report 110.

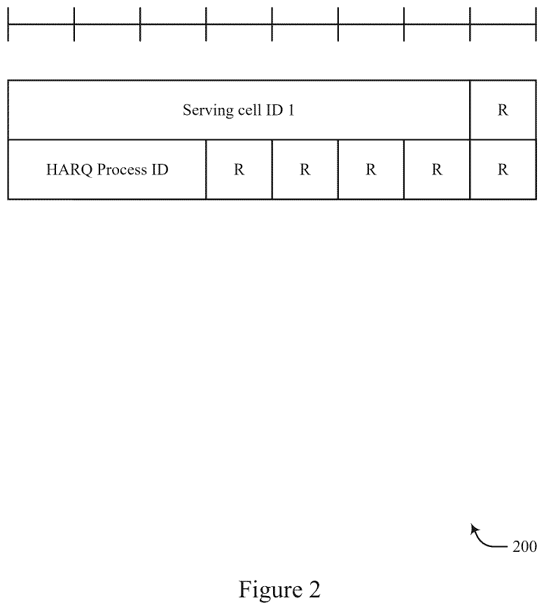

FIG. 2 illustrates an example of a MAC-CE 200 in accordance with aspects of the present disclosure. The MAC-CE 200 may be an example of a feedback report that is generated by a UE, as described herein. In the example of FIG. 2, the MAC-CE 200 may include a first octet having a serving cell ID field and a reserved field (R). The serving cell ID field may identify a serving cell for which HARQ feedback information is reported. In addition, the MAC-CE 200 may include a second octet having a HARQ process ID field and multiple reserved fields (R). The HARQ process ID field may identify the HARQ process for which the UE reports the HARQ feedback, in some cases including a HARQ feedback error indication, corresponding to the HARQ process associated with the transmission of the TB indicated by the DCI. The reserved fields may be used for future extensions or alignment purposes.

As described herein, a UE may generate and transmit HARQ feedback information by means of a HARQ-CE, in some cases, carried in a MAC-CE. The HARQ-CE may include HARQ feedback information associated with at least one TB transmission (e.g., a PDSCH) that is scheduled by a physical downlink control channel (PDCCH) carrying the DCI which identifies a HARQ process. That is, the UE may receive DCI from the NE, the DCI indicating transmission of a TB and indicating the HARQ process associated with the TB transmission. Based on decoding a TB transmission allocated by such a PDCCH, the UE may trigger creation of a corresponding HARQ-CE for the HARQ process used for that TB.

For each triggered HARQ-CE, the UE may start (e.g., begin, initiate) an associated timer that defines a threshold (e.g., maximum) allowed time window for transmitting the HARQ-CE, or equivalently, the MAC-CE carrying that HARQ-CE, on the uplink. While at least one triggered HARQ-CE is pending (e.g., prior to the UE actually generating the HARQ-CE), the UE may monitor the availability of uplink shared channel (UL-SCH) resources for transmitting a MAC PDU including a MAC-CE (e.g., the MAC-CE 200) with the at least one pending HARQ-CE. When UL-SCH resources are available before expiry of a timer associated with the pending HARQ-CEs, the UE may generate a MAC-CE that includes all currently pending HARQ-CEs, such as the MAC-CE 200, and multiplex the MAC-CE into a MAC PDU for transmission on the UL-SCH. In this way, a single MAC-CE may aggregate HARQ feedback information for one or more HARQ processes, including HARQ processes associated with the same serving cell or with different serving cells and/or carriers.

Alternatively, if the UE determines, before expiry of at least one associated timer, that no suitable UL-SCH resources are available for transmission of the MAC-CE carrying all pending HARQ-CEs, then the UE may initiate an uplink resource acquisition procedure to ensure timely delivery of the HARQ feedback. For example, the UE may trigger an SR on a configured physical uplink control channel (PUCCH), requesting UL-SCH resources for transmission of the MAC-CE including the pending HARQ-CEs. In another example, the UE may initiate a RACH procedure to obtain uplink resources when an SR is not configured or would fail to meet the timing requirements. In yet another example, the UE may trigger a contention-based uplink transmission of the MAC-CE, using contention-based UL-SCH resources when available, to convey the at least one HARQ-CE without waiting for explicitly granted resources from the NE. The NE (e.g., by indication, configuration, or definition) may configure the UE to transmit such an SR or initiate such a RACH procedure only if the pending feedback is one of ACK feedback or NACK feedback.

In some cases, when a timer associated with a specific pending HARQ-CE expires before the transmission of the HARQ-CE, the UE may cancel that HARQ-CE and remove the HARQ-CE from the pending set. After cancellation, the UE may refrain from including the cancelled HARQ-CE in a subsequently generated MAC-CE, and from transmitting HARQ feedback corresponding to that cancelled HARQ-CE. If multiple timers expire at different times, the UE may independently cancel each corresponding HARQ-CE while retaining and attempting to transmit remaining HARQ-CEs whose timers have not yet expired.

In some implementations, the UE behavior described herein may be summarized as follows. Based on decoding a TB (e.g., a PDSCH transmission) using a particular HARQ process, the UE may trigger a HARQ-CE including HARQ feedback for that HARQ process and start a dedicated timer associated with the triggered HARQ-CE. While one or more HARQ-CEs are pending, the UE may monitor UL-SCH resource availability. If one or more resources are available before an associated timer expiry, the UE may generate a MAC-CE (e.g., the MAC-CE 200) including all pending HARQ-CEs and transmit the MAC-CE on the available UL-SCH resources. If no resources are available for the uplink transmission of the MAC-CE before an impending timer expiry, the UE may trigger at least one of SR transmission, RACH procedure, or contention-based uplink transmission to send the MAC-CE. In some examples, based on expiry of a timer for a pending HARQ-CE, the UE may cancel the HARQ-CE and exclude the HARQ-CE from a future MAC-CE. This behavior allows the UE to aggregate multiple HARQ feedback reports into a single MAC-CE when possible, while ensuring that each HARQ-CE is either transmitted within a defined maximum delay or explicitly cancelled when the delay constraint cannot be met, thereby providing controlled and timely HARQ feedback with efficient use of uplink resources.

In some cases, a HARQ-CE may, in addition to HARQ feedback such as ACK or NACK, also include further assistance information for future downlink scheduling. For example, the assistance information may include one or more of an MCS, a suggested RB, or an indication of an amount of incremental redundancy for a successful decoding.

Additionally, or alternatively, the HARQ-CE may include HARQ feedback error information in addition to HARQ feedback information associated with a TB transmission. For example, the HARQ feedback error information may include a NACK-to-ACK error indication. In some cases, the UE may receive a DCI with a toggled NDI indicating an initial TB transmission for a HARQ process. This may occur even if the UE incorrectly decoded a previous TB transmission for the same HARQ process and the UE sent a NACK as HARQ feedback to the NE. In such cases, a NACK-to-ACK error may have occurred, where the UE transmitted a NACK but the NE detected an ACK. As such, to assist downlink scheduling and make the NE aware of potential HARQ feedback errors, a UE may also trigger the transmission of a HARQ feedback error indication via a HARQ-CE on the uplink. In some examples, the UE may start a timer in response to triggering generation of a HARQ-CE that includes a HARQ feedback error indication. In one example, the configuration of such a timer (e.g., a timer value or length) may be different for a HARQ feedback error indication compared to HARQ feedback including an ACK or a NACK. In such cases, the UE may use the MAC-CE 200 to indicate a HARQ feedback error, such as when the UE detects or assumes that a NACK-to-ACK error has occurred. For example, when the UE receives DCI indicating a new transmission for a HARQ process even though the previous transmission for the same HARQ process was not correctly decoded and the UE sent a NACK as HARQ feedback, the UE may generate the MAC-CE 200 to report the HARQ feedback error indication to the NE. The MAC-CE 200 may be transmitted on one or more uplink resources that are available for transmission of the feedback report while a timer associated with the feedback report is running.

The NE may determine, for example based on a received HARQ-CE that includes a HARQ feedback error indication, that a NACK-to-ACK error occurred for a HARQ process. In such cases, if the NE had not willingly stopped further HARQ retransmissions, the NE may perform further retransmissions for that HARQ process. In some examples, the UE may consider the HARQ process as free or available if it does not receive a further retransmission within a certain predefined time limit, or within a certain number of subsequent downlink schedulings, such that the UE may assume that no further retransmission(s) will follow.

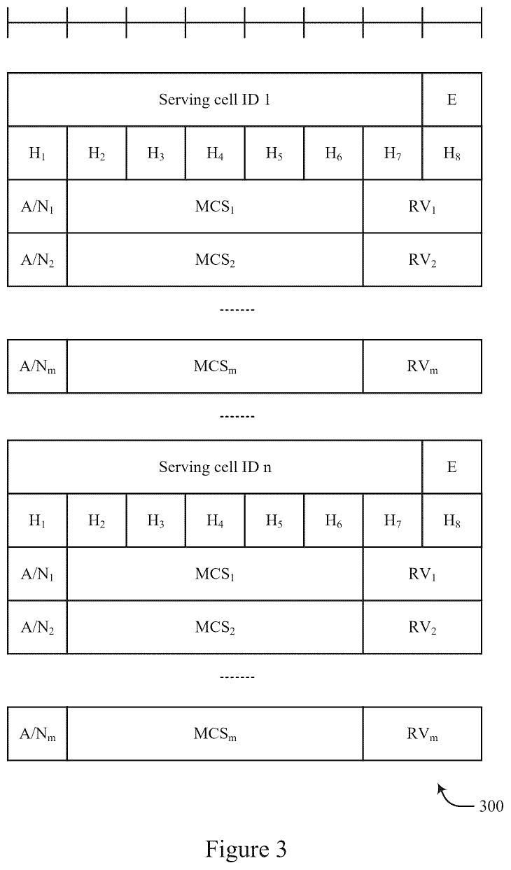

FIG. 3 illustrates an example of a MAC-CE 300 in accordance with aspects of the present disclosure. The MAC-CE 300 may be an example of a feedback report that is generated by a UE, as described herein. In the example of FIG. 3, the MAC-CE 300 includes a structure organized to support multiple serving cells, for example, in a carrier aggregation scenario. The MAC-CE 300 may include serving cell ID fields (serving cell ID 1 through serving cell ID n), where each serving cell ID field may identify a serving cell for which the UE is reporting HARQ feedback information. Each serving cell ID field may correspond to an extension field (E) in a same respective octet. An extension field may indicate whether additional serving cell entries follow. A bitmap, represented by header fields H1 through H8, may be used to indicate for which of the HARQ processes of the serving cell HARQ feedback information and scheduling assistance information is reported. A bit of the bitmap set to a first value (e.g., ‘1’) may indicate that HARQ feedback and scheduling assistance information is included for the corresponding HARQ process.

For each serving cell, the MAC-CE 300 may include a header row including header fields H1 through H8, which may represent a bitmap indicating for which of the HARQ processes of the serving cell HARQ feedback information and scheduling assistance information is reported. Below the header row, the MAC-CE 300 may include multiple entries corresponding to different HARQ processes. Each entry may include an ACK or NACK field (A/N1 through A/Nm), which may correspond to the HARQ feedback that indicates whether the UE correctly decoded the TB. Each entry may also include an MCS field (MCS1 through MCSm) and an RV field (RV1 through RVm). The MCS and RV fields may correspond to the assistance information for scheduling subsequent downlink transmission.

In some implementations, the UE may start a first discontinuous reception (DRX) related timer in response to having transmitted the MAC-CE 300 carrying HARQ-CEs (e.g., including a HARQ feedback indication), on the PUSCH. In one example, the UE may start the timer in the first symbol after the end of a corresponding initial PUSCH transmission carrying HARQ feedback. In another example, the UE may start the timer based on receiving an ACK or confirmation of the successful reception of the MAC-CE from the NE. In some implementations, the UE may start monitoring a PDCCH (e.g., DCI) for scheduling potential retransmission(s) of a TB transmission for which a NACK (unsuccessful decoding) was indicated in the MAC-CE upon expiry of the first DRX-related timer. In one example, the UE may start a second DRX-related timer upon expiry of the first timer, where the second timer may control the active time of the UE, such as monitoring PDCCH. In some examples, the second timer may be a drx-RetransmissionTimerDL. In some examples, the UE may start the first timer and/or the second timer only for cases when the UE reported NACK feedback as HARQ feedback on the MAC-CE.

For cases where the MAC-CE includes HARQ feedback information for multiple HARQ processes, the UE may start a first DRX-related timer for each of the HARQ processes for which HARQ feedback information is included in the MAC-CE. In some implementations, the UE may be enabled to transmit HARQ feedback information on a PUSCH even during time periods where the NE has activated a cell DRX mode, such as when the NE is not monitoring for uplink transmissions from the UE. Since the NE may be aware of the HARQ feedback transmission from the UE for a downlink TB, the NE may monitor for the corresponding PUSCH transmissions carrying the HARQ feedback information even during cell DRX periods. In some implementations, the UE may be configured, for example on a HARQ process level, whether HARQ feedback transmission on PUSCH is permitted during cell DRX periods. The permission to transmit HARQ feedback on PUSCH during cell DRX periods may depend on the importance of the data contained in the corresponding TB transmission, where the NE may indicate such importance within the associated DCI or PDCCH.

In some examples, an NE may transmit DCI to a UE, where the DCI indicates one or more resources (e.g., PUSCH resources) for uplink transmission of HARQ feedback associated with a downlink transmission. In some examples, the NE may transmit the DCI via a PDCCH. Alternatively, the NE may indicate the one or more resources via a radio resource control (RRC) configuration.

In some implementations, the NE may configure multiple resources (e.g., uplink resources) for the UE and indicate to the UE, in the DCI, whether the UE is to use one of the multiple resources for the HARQ feedback transmission, and if so, which of the multiple resources to use. In some such cases, the DCI may also schedule a downlink data transmission for which the UE is to transmit the HARQ feedback. As there may be cases where the UE is to transmit a different number of HARQ feedback bits (e.g., corresponding to multiple HARQ processes or multiple TBs), the corresponding HARQ feedback payload may not be known at the time the NE configures the resources for the HARQ feedback transmission. Additionally, or alternatively, radio channel conditions may fluctuate dynamically such that a slowly configurable resource for the HARQ feedback transmission may provide inefficient or insufficient resources for an error-free transmission of the HARQ feedback. Accordingly, the NE may configure the multiple resources (or multiple resources configurations), and the NE may flexibly select and indicate one or more particular resources to the UE.

In some implementations, the DCI may include a field that indicates which of the one or more resources to use for the uplink transmission of the HARQ feedback. For example, the DCI may explicitly indicate a resource (e.g., by a resource index) that the UE is to use for the HARQ feedback transmission. Additionally, or alternatively, the DCI may indicate whether and when the HARQ feedback should be transmitted, in some cases, by including timing information for the transmission of the HARQ feedback. In some cases, for example, the DCI may indicate a threshold (e.g., maximum) time after reception of the DCI or reception of a TB transmission until (e.g., up to) which the UE is to transmit the HARQ feedback. That is, the DCI may indicate a maximum allowed time for the UE to wait for available resources (e.g., PUSCH resources), which may be scheduled by a DCI received later than the DCI scheduling the downlink transmission. The UE may transmit an SR or a RACH message to the NE to obtain such a resource.

Additionally, or alternatively, the DCI may indicate whether to transmit the HARQ feedback according to an indicated or determined timing, such as a first timing on a PUCCH or a second timing on a PUSCH. For example, the DCI may indicate to transmit the HARQ feedback on a next available PUSCH resource that is available at least a number of time units (e.g., slots, symbols, subframes, etc.) after the reception of the DCI or reception of a TB. If no such transmission opportunity is available, the UE may transmit an SR or a RACH transmission to obtain resources for the HARQ transmission. In some cases (e.g., based on an indication or configuration by the NE), the UE may transmit the SR or RACH only if the pending HARQ feedback includes an ACK, where the NE assumes the HARQ feedback would instead be a NACK if the NE received no feedback from the UE, or if the pending HARQ feedback includes a NACK, where the NE assumes the HARQ feedback would instead be an ACK if the NE received no feedback from the UE. As such, the NE may limit radio resource usage for transmission of an SR or a RACH in case the NE would assume or expect a NACK or an ACK, respectively, if no feedback from the UE is received. Additionally, or alternatively, the DCI may indicate whether to transmit the HARQ feedback on a PUCCH or a PUSCH. The indication of whether to transmit the HARQ feedback on a PUCCH or a PUSCH may be included in timing information indicated in the DCI.

Additionally, or alternatively, the DCI may indicate whether the UE is to protect the transmission of the HARQ feedback by adding a checksum, such as a forward error correction code or a CRC with or without a forward error correction code. For example, if the DCI indicates to protect the HARQ feedback transmission using a CRC, the DCI may also indicate (e.g., as configured or defined by the NE), a length of the CRC (i.e., a number of CRC bits).

In some implementations, the UE may be limited to a subset of LCHs or LCGs that the UE may multiplex or transmit in a given uplink resource. For example, the UE may be limited to multiplexing or transmitting only MAC-CEs in a TB that the UE transmits using an uplink resource. In such cases, the NE may configure or indicate such limitations to the UE. For example, the DCI may indicate that the one or more resources support transmission of one or more LCHs or one or more LCGs. Such limitations may ensure that regardless of other defined traffic priorities, the indicated resources are exclusively or primarily available for the transmission of the HARQ feedback. In some implementations, the DCI may indicate whether such a limitation on the usage of the indicated one or more resources is applicable or not. For example, the DCI may indicate specific time instances, such as slots, symbols, or subframes, in which the limitation is applicable. For example, the UE may multiplex particular LCGs only in some slots but not others. In some implementations, the DCI that indicates whether such limitations are applicable may be the same DCI that indicates the one or more resources for transmission of the HARQ feedback or a different DCI.

In some implementations, the UE may be capable of multiplexing the HARQ feedback with other data. In such cases, the UE may map the HARQ feedback (e.g., included in a MAC CE) to the beginning of a TB, which may allow for early processing of the HARQ feedback at the receiver (e.g., the NE) and facilitate a short turn-around time for retransmissions of the data associated with the HARQ feedback (e.g., if the HARQ feedback includes a NACK). Alternatively, in cases where the UE multiplexes the HARQ feedback with other data, the UE may map the HARQ feedback (e.g., included in a MAC CE) to the end of a TB, which may provide the UE with additional processing time to generate HARQ feedback for multiple downlink transmissions and may facilitate resource-efficient HARQ feedback transmissions. In such cases, the DCI may indicate whether the UE is allowed to multiplex the HARQ feedback with other data on one or more resources. The DCI that indicates whether the UE is allowed to multiplex the HARQ feedback with other data may be the same DCI that indicates the one or more resources for transmission of the HARQ feedback or a different DCI.

In some examples, the NE may transmit, to the UE, second DCI that indicates transmission of a TB and whether a HARQ process (e.g., a HARQ protocol) for the TB or for a previous (e.g., earlier) TB is aborted. The second DCI may include various types of indications related to HARQ process management. For example, the second DCI may indicate that the transmission of a TB is a last HARQ transmission of the TB corresponding to a HARQ process. In such cases, the UE may determine, in some cases by checking for a non-toggled NDI, that the UE is not expected to transmit HARQ feedback for the corresponding TB transmission. The NDI is a field in the second DCI that may indicate whether the TB is a new transmission or a retransmission. A toggled NDI may indicate a new TB, and a non-toggled NDI may indicate a retransmission of a previous TB.

Additionally, or alternatively, the second DCI may indicate that the NE aborted a TB that the NE previously transmitted using an indicated HARQ process. In such implementations, the UE may infer from such information, and in some cases from a toggled NDI, that the TB indicated by the second DCI is a new TB, and that the UE may discard the previous content of a corresponding HARQ buffer (e.g., a memory location at the UE that stores information from previous transmissions of a TB to enable soft combining with subsequent retransmissions). In some cases, the indication that the previous (e.g., earlier) TB transmission associated with the HARQ process is aborted may imply that the UE is not expected to generate a HARQ failure report for the aborted TB, which may indicate that a TB could not be successfully decoded after a threshold (e.g., maximum) number of retransmissions. In some implementations, the UE may infer from the indication that the previous TB transmission associated with the HARQ process is aborted, and in some cases from a toggled NDI, that the UE should trigger a higher-layer retransmission of a TBcorresponding to the aborted TB. For example, the UE may trigger a Radio Link Control (RLC) retransmission. In some examples, the NDI may be extended, or an explicit bit may be used in the second DCI, to indicate an abort signaling for a certain HARQ process ID, at least for the HARQ process indicated in the second DCI. If the HARQ process is indicated as aborted and the NDI is toggled, the UE may discard information associated with the previous TB, such that no anomaly needs to be reported, and the UE may flush the soft buffer associated with the HARQ process. Alternatively, if the HARQ process is indicated as aborted and the NDI is not toggled, the UE may attempt to decode or soft combine the received transmission but may refrain from reporting further HARQ feedback for the TB. In some examples, a HARQ process associated with TB transmissions may have incremental redundancy, which may involve the NE 102 transmitting additional parity bits or coded bits in each retransmission. The UE 104 may combine the additional bits with previously received bits to improve the likelihood of successful decoding of the TB.

In some examples, based on the DCI, the UE may determine (e.g., identify, select) a resource of the one or more resources for the uplink transmission of the HARQ feedback. For example, if the DCI includes a field that indicates which of the one or more resources to use for the uplink transmission of the HARQ feedback, the UE may determine the resource based on the field. In some examples, the UE may determine the resource of the one or more resources only if the UE has HARQ feedback associated with a downlink transmission to transmit to the NE (e.g., in response to receiving the downlink transmission). Otherwise, if the UE lacks HARQ feedback, the UE may skip the one or more resources indicated in the DCI. In this way, the UE may only use the one or more resources for transmitting the HARQ feedback, which may be multiplexed with other data in some cases, and refrain from using the one or more resources for transmissions without HARQ feedback. This may enable the NE to configure identical resources for multiple UEs while also ensuring that only one of the UEs utilizes the resource(s) based on appropriate indication and scheduling by DCI.

The UE may transmit the HARQ feedback to the NE on the determined resource. In some implementations, the UE may map bits of the HARQ feedback to a subset of bits of a modulation symbol and transmit the HARQ feedback using one or more bits based on the mapping. That is, the UE may map the bits pertaining to (e.g., associated with, configured for) the HARQ feedback to a subset of bits of a modulation symbol that have a higher error resilience than other bits of a modulation symbol. For example, in a modulation symbol employing 16-quadrature amplitude modulation (QAM), which allows four bits (e.g., b₁b₂b₃b₄) to be transmitted in one symbol, two bits, b₁ and b₂, may have a higher error resilience than the other two bits. In such cases, the UE may transmit the HARQ feedback using the first two bits, b₁ and b₂, and transmit other information (e.g., associated with user data) using the other two bits, b₃ and b₄.

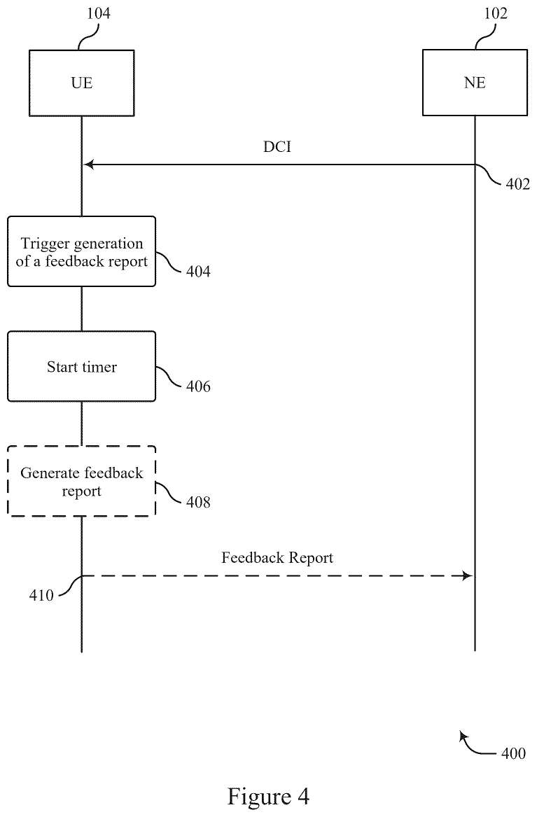

FIG. 4 illustrates an example of a signaling diagram 400 in accordance with aspects of the present disclosure. In some examples, the signaling diagram 400 implements or is implemented by aspects of the wireless communications system 100, the MAC-CE 200, and the MAC-CE 300. The signaling diagram 400 may implement or be implemented by an NE 102 and a UE 104, which may be examples of the corresponding devices as described with reference to FIGS. 1 through 3. Alternative examples of the following may be implemented, where some processes are performed in a different order than described or are not performed. In some cases, processes may include additional features not mentioned below, or further processes may be added.

At 402, the NE 102 may transmit DCI to the UE 104. The DCI indicates transmission of a TB and indicates a HARQ process associated with the transmission. For example, the DCI may schedule a TB or PDSCH transmission and identify the HARQ process used for that TB. The DCI may be transmitted via a PDCCH.

At 404, the UE 104 may trigger, based on the DCI, generation of a feedback report associated with the TB and the HARQ process. For example, upon decoding a TB transmission allocated by the PDCCH carrying the DCI, the UE 104 may trigger creation of a corresponding feedback report for the HARQ process used for that TB. The feedback report may include HARQ feedback that indicates whether the UE 104 correctly decoded the TB. The feedback report may include an ID associated with the HARQ process (e.g., a HARQ process ID). In some examples, the feedback report may include assistance information for scheduling subsequent downlink transmission, where the assistance information includes one or more of an MCS, an RV, or an amount of incremental redundancy.

At 406, the UE 104 may start a timer based on triggering the generation of the feedback report. The timer may define a threshold (e.g. maximum) allowed time window for transmitting the feedback report on the uplink. The timer ensures that the feedback report is transmitted in a timely manner to support efficient HARQ operation.

At 408, the UE 104 may determine, while the timer is running, that one or more resources are available for transmission of the feedback report, and generate the feedback report based on determining that the one or more resources are available. To generate the feedback report, the UE 104 may generate a MAC-CE. The feedback report may be included in the MAC-CE and may include HARQ feedback for one or more HARQ processes, where the one or more HARQ processes include the HARQ process associated with the transmission of the TB. In some examples, the MAC-CE may aggregate HARQ feedback information for multiple HARQ processes, including HARQ processes associated with the same serving cell or with different serving cells and/or carriers.

At 410, the UE 104 may transmit the feedback report on the one or more resources. For example, the UE 104 may transmit the MAC-CE on the one or more resources. The UE 104 may stop the timer based on transmission of the MAC-CE. In some examples, if the timer expires before the UE 104 determines that resources are available for the uplink transmission of the feedback report, then the UE 104 may cancel the feedback report based on an expiration of the timer.

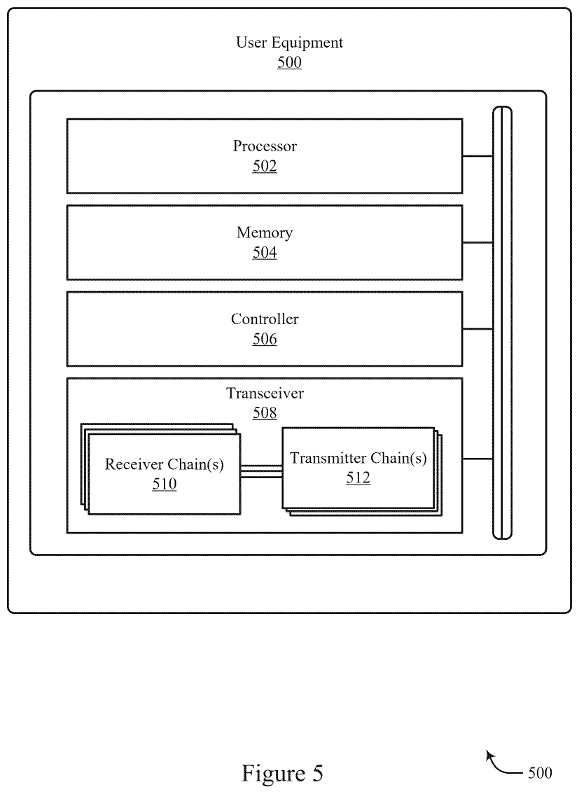

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving DCI that indicates transmission of a TB and indicates a HARQ process associated with the transmission, triggering, based on the DCI, generation of a feedback report associated with the TB and the HARQ process, and starting a timer based on triggering the generation of the feedback report. In this manner, the UE 500 supports improved HARQ feedback transmission reliability and reduced NACK-to-ACK errors by enabling timer-based management of feedback report generation, which enhances resource utilization and provides controlled timing for uplink feedback transmissions.

Additionally, the UE 500 may be configured to support any one or combination of the following. For example, the UE 500 may be configured to or operable to support determining, while the timer is running, that one or more resources are available for transmission of the feedback report, generating the feedback report based on determining that the one or more resources are available, and transmitting the feedback report on the one or more resources. This aspect improves resource utilization efficiency by allowing the UE 500 to dynamically identify available uplink resources within the timing window, ensuring timely feedback delivery while avoiding resource conflicts. Additionally, or alternatively, to generate the feedback report, the UE 500 may be configured to or operable to support generating a MAC-CE and transmitting the MAC-CE on the one or more resources. This aspect enables efficient multiplexing of feedback information through the MAC layer, improving reliability compared to other feedback mechanisms and supporting aggregation of multiple HARQ feedback reports. Additionally, or alternatively, the UE 500 may be configured to or operable to support where the feedback report is included in the MAC-CE and includes HARQ feedback for one or more HARQ processes, and the one or more HARQ processes include the HARQ process associated with the transmission of the TB. This aspect enhances transmission efficiency by enabling aggregation of HARQ feedback for multiple processes into a single MAC-CE, reducing signaling overhead and improving resource utilization.

Additionally, or alternatively, the UE 500 may be configured to or operable to support stopping the timer based on transmission of the MAC-CE. This aspect provides clear state management for the feedback process, preventing redundant timer operations and ensuring proper synchronization between feedback transmission and timer control. Additionally, or alternatively, the UE 500 may be configured to or operable to support receiving, based on incorrect reception of the transmission of the TB, second DCI that indicates transmission of a second TB and indicates the HARQ process associated with the transmission of the second TB, and triggering, based on the second DCI, generation of a second feedback report associated with the second TB and the HARQ process, where the second feedback report includes a HARQ feedback error indication. This aspect enables detection and reporting of NACK-to-ACK errors, allowing the network to take corrective action and schedule appropriate retransmissions, thereby reducing data loss and improving overall transmission reliability. Additionally, or alternatively, the UE 500 may be configured to or operable to support starting a second timer based on triggering the generation of the second feedback report. This aspect ensures that error indication reports are also subject to timing constraints, maintaining consistent feedback delivery timing and preventing stale error reports from being transmitted.

Additionally, or alternatively, the UE 500 may be configured to or operable to support where the feedback report includes HARQ feedback that indicates whether the UE correctly decoded the TB. This aspect provides explicit ACK/NACK information to the network, enabling accurate determination of retransmission requirements and improving overall HARQ protocol efficiency. Additionally, or alternatively, the UE 500 may be configured to or operable to support where the feedback report includes assistance information for scheduling subsequent downlink transmission, where the assistance information includes one or more of an MCS, an RV, or an amount of incremental redundancy. This aspect enables the network to optimize retransmission parameters based on UE-provided channel quality information, improving the likelihood of successful decoding on subsequent transmissions and reducing overall latency. Additionally, or alternatively, the UE 500 may be configured to or operable to support where the feedback report includes an ID associated with the HARQ process. This aspect enables unambiguous identification of the HARQ process for which feedback is being provided, ensuring proper correlation between feedback reports and corresponding data transmissions. Additionally, or alternatively, the UE 500 may be configured to or operable to support canceling the feedback report based on an expiration of the timer. This aspect prevents stale feedback from being transmitted after the timing window has elapsed, improving overall system efficiency and ensuring that only timely feedback is delivered to the network.

Additionally, or alternatively, the UE 500 may support at least one memory (e.g., the memory 504) and at least one processor (e.g., the processor 502) coupled with the at least one memory and configured to cause the UE to receive DCI that indicates transmission of a TB and indicates a HARQ process associated with the transmission, trigger, based on the DCI, generation of a feedback report associated with the TB and the HARQ process, and start a timer based on triggering the generation of the feedback report. In this manner, the UE 500 supports improved HARQ feedback transmission reliability and reduced NACK-to-ACK errors by enabling timer-based management of feedback report generation, which enhances resource utilization and provides controlled timing for uplink feedback transmissions.

Additionally, the UE 500 may be configured to support any one or combination of the following. For example, the UE 500 may be configured or operable to support determining, while the timer is running, that one or more resources are available for transmission of the feedback report, generating the feedback report based on determining that the one or more resources are available, and transmitting the feedback report on the one or more resources. This aspect improves resource utilization efficiency by allowing the UE 500 to dynamically identify available uplink resources within the timing window, ensuring timely feedback delivery while avoiding resource conflicts. Additionally, or alternatively, to generate the feedback report, the UE 500 may be configured to or operable to support generating a MAC-CE and transmitting the MAC-CE on the one or more resources. This aspect enables efficient multiplexing of feedback information through the MAC layer, improving reliability compared to other feedback mechanisms and supporting aggregation of multiple HARQ feedback reports. Additionally, or alternatively, the UE 500 may be configured to or operable to support where the feedback report is included in the MAC-CE and includes HARQ feedback for one or more HARQ processes, and the one or more HARQ processes include the HARQ process associated with the transmission of the TB. This aspect enhances transmission efficiency by enabling aggregation of HARQ feedback for multiple processes into a single MAC-CE, reducing signaling overhead and improving resource utilization.

Additionally, or alternatively, the UE 500 may be configured to or operable to support stopping the timer based on transmission of the MAC-CE. This aspect provides clear state management for the feedback process, preventing redundant timer operations and ensuring proper synchronization between feedback transmission and timer control. Additionally, or alternatively, the UE 500 may be configured to or operable to support receiving, based on incorrect reception of the transmission of the TB, second DCI that indicates transmission of a second TB and indicates the HARQ process associated with the transmission of the second TB, and triggering, based on the second DCI, generation of a second feedback report associated with the second TB and the HARQ process, where the second feedback report includes a HARQ feedback error indication. This aspect enables detection and reporting of NACK-to-ACK errors, allowing the network to take corrective action and schedule appropriate retransmissions, thereby reducing data loss and improving overall transmission reliability. Additionally, or alternatively, the UE 500 may be configured to or operable to support starting a second timer based on triggering the generation of the second feedback report. This aspect ensures that error indication reports are also subject to timing constraints, maintaining consistent feedback delivery timing and preventing stale error reports from being transmitted. Additionally, or alternatively, the UE 500 may be configured to or operable to support where the feedback report includes HARQ feedback that indicates whether the UE correctly decoded the TB. This aspect provides explicit ACK/NACK information to the network, enabling accurate determination of retransmission requirements and improving overall HARQ protocol efficiency.

Additionally, or alternatively, the UE 500 may be configured to or operable to support where the feedback report includes assistance information for scheduling subsequent downlink transmission, where the assistance information includes one or more of an MCS, an RV, or an amount of incremental redundancy. This aspect enables the network to optimize retransmission parameters based on UE-provided channel quality information, improving the likelihood of successful decoding on subsequent transmissions and reducing overall latency. Additionally, or alternatively, the UE 500 may be configured to or operable to support where the feedback report includes an ID associated with the HARQ process. This aspect enables unambiguous identification of the HARQ process for which feedback is being provided, ensuring proper correlation between feedback reports and corresponding data transmissions. Additionally, or alternatively, the UE 500 may be configured to or operable to support canceling the feedback report based on an expiration of the timer. This aspect prevents stale feedback from being transmitted after the timing window has elapsed, improving overall system efficiency and ensuring that only timely feedback is delivered to the network.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

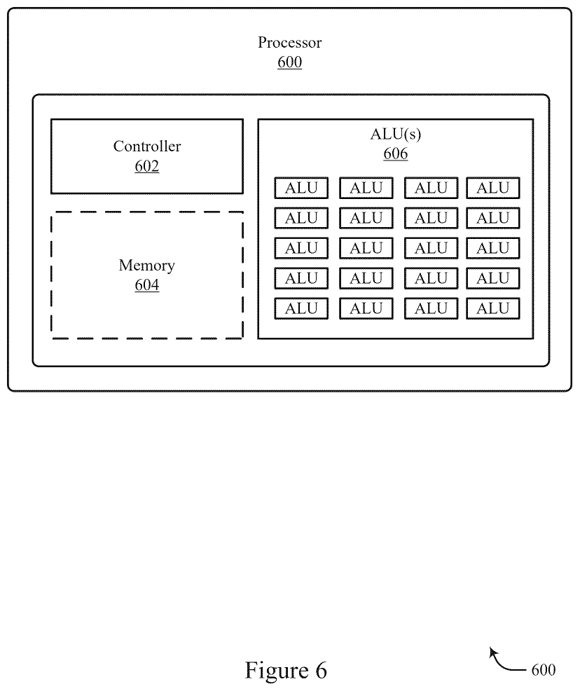

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may include at least one memory 604, which may be, for example, an L1/L2/L3 cache. Additionally, or alternatively, the processor 600 may include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive DCI that indicates transmission of a TB and indicates a HARQ process associated with the transmission, trigger, based on the DCI, generation of a feedback report associated with the TB and the HARQ process, and start a timer based on triggering the generation of the feedback report. In this manner, the processor 600 supports improved HARQ feedback transmission reliability and reduced NACK-to-ACK errors by enabling timer-based management of feedback report generation, which enhances resource utilization and provides controlled timing for uplink feedback transmissions.

Additionally, the processor 600 may be configured to support any one or combination of the following. For example, the may be configured or operable to support determining, while the timer is running, that one or more resources are available for transmission of the feedback report, generating the feedback report based on determining that the one or more resources are available, and transmitting the feedback report on the one or more resources. This aspect improves resource utilization efficiency by allowing the processor 600 to dynamically identify available uplink resources within the timing window, ensuring timely feedback delivery while avoiding resource conflicts. Additionally, or alternatively, to generate the feedback report, the processor 600 may be configured to or operable to support generating a MAC-CE and transmitting the MAC-CE on the one or more resources. This aspect enables efficient multiplexing of feedback information through the MAC layer, improving reliability compared to other feedback mechanisms and supporting aggregation of multiple HARQ feedback reports. Additionally, or alternatively, the processor 600 may be configured to or operable to support where the feedback report is included in the MAC-CE and includes HARQ feedback for one or more HARQ processes, and the one or more HARQ processes include the HARQ process associated with the transmission of the TB. This aspect enhances transmission efficiency by enabling aggregation of HARQ feedback for multiple processes into a single MAC-CE, reducing signaling overhead and improving resource utilization.

Additionally, or alternatively, the processor 600 may be configured to or operable to support stopping the timer based on transmission of the MAC-CE. This aspect provides clear state management for the feedback process, preventing redundant timer operations and ensuring proper synchronization between feedback transmission and timer control. Additionally, or alternatively, the processor 600 may be configured to or operable to support receiving, based on incorrect reception of the transmission of the TB, second DCI that indicates transmission of a second TB and indicates the HARQ process associated with the transmission of the second TB, and triggering, based on the second DCI, generation of a second feedback report associated with the second TB and the HARQ process, where the second feedback report includes a HARQ feedback error indication. This aspect enables detection and reporting of NACK-to-ACK errors, allowing the network to take corrective action and schedule appropriate retransmissions, thereby reducing data loss and improving overall transmission reliability. Additionally, or alternatively, the processor 600 may be configured to or operable to support starting a second timer based on triggering the generation of the second feedback report. This aspect ensures that error indication reports are also subject to timing constraints, maintaining consistent feedback delivery timing and preventing stale error reports from being transmitted. Additionally, or alternatively, the processor 600 may be configured to or operable to support where the feedback report includes HARQ feedback that indicates whether the UE correctly decoded the TB. This aspect provides explicit ACK/NACK information to the network, enabling accurate determination of retransmission requirements and improving overall HARQ protocol efficiency.

Additionally, or alternatively, the processor 600 may be configured to or operable to support where the feedback report includes assistance information for scheduling subsequent downlink transmission, where the assistance information includes one or more of an MCS, an RV, or an amount of incremental redundancy. This aspect enables the network to optimize retransmission parameters based on UE-provided channel quality information, improving the likelihood of successful decoding on subsequent transmissions and reducing overall latency. Additionally, or alternatively, the processor 600 may be configured to or operable to support where the feedback report includes an ID associated with the HARQ process. This aspect enables unambiguous identification of the HARQ process for which feedback is being provided, ensuring proper correlation between feedback reports and corresponding data transmissions. Additionally, or alternatively, the processor 600 may be configured to or operable to support canceling the feedback report based on an expiration of the timer. This aspect prevents stale feedback from being transmitted after the timing window has elapsed, improving overall system efficiency and ensuring that only timely feedback is delivered to the network.

Additionally, or alternatively, the processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit DCI that indicates transmission of a TB and indicates a HARQ process associated with the transmission, where the DCI triggers generation of a feedback report associated with the TB and the HARQ process. In this manner, the NE 700 supports improved HARQ feedback transmission reliability and reduced NACK-to-ACK errors by enabling controlled triggering of feedback report generation, which enhances overall transmission reliability and reduces data loss caused by feedback errors

Additionally, or alternatively, the processor 600 may be configured to or operable to support any one or combination of the following. For example, the processor 600 may be configured to or operable to support where a timer is started based on the generation of the feedback report being triggered, and receiving the feedback report associated with the TB and the HARQ process based on one or more resources being available for transmission of the feedback report while the timer is running. This aspect improves resource utilization efficiency by enabling timer-based management of feedback report reception within a defined timing window, ensuring timely feedback delivery while avoiding resource conflicts at the processor 600. Additionally, or alternatively, the processor 600 may be configured to or operable to support receiving a MAC-CE on the one or more resources, where the MAC-CE includes the feedback report. This aspect enables efficient multiplexing of feedback information through the MAC layer, improving reliability compared to other feedback mechanisms and supporting aggregation of multiple HARQ feedback reports at the processor 600. Additionally, or alternatively, the processor 600 may be configured to or operable to support where the feedback report is included in the MAC-CE and includes HARQ feedback for one or more HARQ processes, and the one or more HARQ processes include the HARQ process associated with the transmission of the TB. This aspect enhances transmission efficiency by enabling aggregation of HARQ feedback for multiple processes into a single MAC-CE, reducing signaling overhead and improving resource utilization at the processor 600.

Additionally, or alternatively, the processor 600 may be configured to or operable to support where the timer is stopped based on transmission of the MAC-CE. This aspect provides clear state management for the feedback process, preventing redundant timer operations and ensuring proper synchronization between feedback transmission and timer control at the processor 600. Additionally, or alternatively, the processor 600 may be configured to or operable to support transmitting, based on incorrect reception of the transmission of the TB by a UE, second DCI that indicates transmission of a second TB and indicates the HARQ process associated with the transmission of the second TB, and receiving a second feedback report associated with the second TB on one or more resources, where the second feedback report includes a HARQ feedback error indication. This aspect enables detection and reporting of NACK-to-ACK errors, allowing the processor 600 to take corrective action and schedule appropriate retransmissions, thereby reducing data loss and improving overall transmission reliability. Additionally, or alternatively, the processor 600 may be configured to or operable to support where the feedback report includes an ID associated with the HARQ process. This aspect enables unambiguous identification of the HARQ process for which feedback is being provided, ensuring proper correlation between feedback reports and corresponding data transmissions at the processor 600.

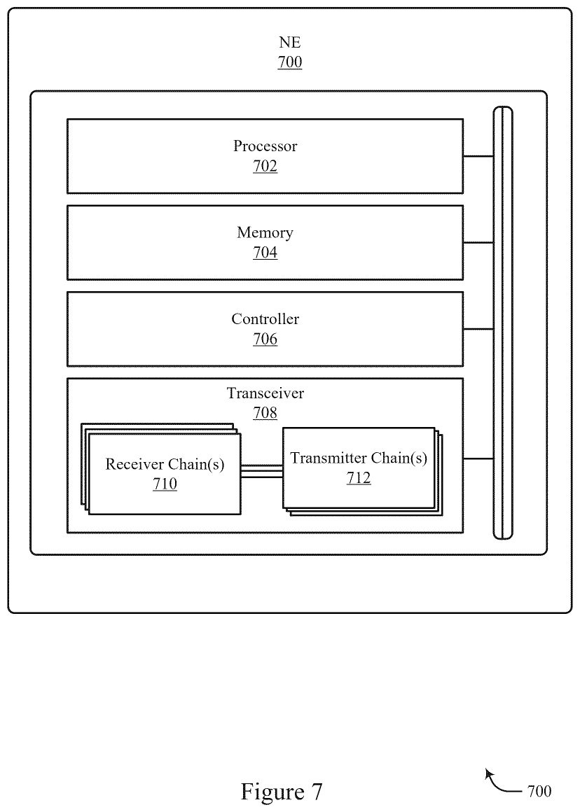

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting DCI that indicates transmission of a TB and indicates a HARQ process associated with the transmission, where the DCI triggers generation of a feedback report associated with the TB and the HARQ process. In this manner, the NE 700 supports improved HARQ feedback transmission reliability and reduced NACK-to-ACK errors by enabling controlled triggering of feedback report generation, which enhances overall transmission reliability and reduces data loss caused by feedback errors.

Additionally, the NE 700 may be configured to or operable to support any one or combination of the following. For example, the NE 700 may be configured to or operable to support where a timer is started based on the generation of the feedback report being triggered, and receiving the feedback report associated with the TB and the HARQ process based on one or more resources being available for transmission of the feedback report while the timer is running. This aspect improves resource utilization efficiency by enabling timer-based management of feedback report reception within a defined timing window, ensuring timely feedback delivery while avoiding resource conflicts at the NE 700. Additionally, or alternatively, the NE 700 may be configured to or operable to support receiving a MAC-CE on the one or more resources, where the MAC-CE includes the feedback report. This aspect enables efficient multiplexing of feedback information through the MAC layer, improving reliability compared to other feedback mechanisms and supporting aggregation of multiple HARQ feedback reports at the NE 700. Additionally, or alternatively, the NE 700 may be configured to or operable to support where the feedback report is included in the MAC-CE and includes HARQ feedback for one or more HARQ processes, and the one or more HARQ processes include the HARQ process associated with the transmission of the TB. This aspect enhances transmission efficiency by enabling aggregation of HARQ feedback for multiple processes into a single MAC-CE, reducing signaling overhead and improving resource utilization at the NE 700.

Additionally, or alternatively, the NE 700 may be configured to or operable to support where the timer is stopped based on transmission of the MAC-CE. This aspect provides clear state management for the feedback process, preventing redundant timer operations and ensuring proper synchronization between feedback transmission and timer control at the NE 700. Additionally, or alternatively, the NE 700 may be configured to or operable to support transmitting, based on incorrect reception of the transmission of the TB by a UE, second DCI that indicates transmission of a second TB and indicates the HARQ process associated with the transmission of the second TB, and receiving a second feedback report associated with the second TB on one or more resources, where the second feedback report includes a HARQ feedback error indication. This aspect enables detection and reporting of NACK-to-ACK errors, allowing the NE 700 to take corrective action and schedule appropriate retransmissions, thereby reducing data loss and improving overall transmission reliability. Additionally, or alternatively, the NE 700 may be configured to or operable to support where the feedback report includes an ID associated with the HARQ process. This aspect enables unambiguous identification of the HARQ process for which feedback is being provided, ensuring proper correlation between feedback reports and corresponding data transmissions at the NE 700.

Additionally, or alternatively, the NE 700 may support at least one memory (e.g., the memory 704) and at least one processor (e.g., the processor 702) coupled with the at least one memory and configured to cause the NE to transmit DCI that indicates transmission of a TB and indicates a HARQ process associated with the transmission, where the DCI triggers generation of a feedback report associated with the TB and the HARQ process. In this manner, the NE 700 supports improved HARQ feedback transmission reliability and reduced NACK-to-ACK errors by enabling controlled triggering of feedback report generation, which enhances overall transmission reliability and reduces data loss caused by feedback errors.

Additionally, the NE 700 may be configured to or operable to support any one or combination of the following. For example, the NE 700 may be configured to or operable to support where a timer is started based on the generation of the feedback report being triggered, and receiving the feedback report associated with the TB and the HARQ process based on one or more resources being available for transmission of the feedback report while the timer is running. This aspect improves resource utilization efficiency by enabling timer-based management of feedback report reception within a defined timing window, ensuring timely feedback delivery while avoiding resource conflicts at the NE 700. Additionally, or alternatively, the NE 700 may be configured to or operable to support receiving a MAC-CE on the one or more resources, where the MAC-CE includes the feedback report. This aspect enables efficient multiplexing of feedback information through the MAC layer, improving reliability compared to other feedback mechanisms and supporting aggregation of multiple HARQ feedback reports at the NE 700. Additionally, or alternatively, the NE 700 may be configured to or operable to support where the feedback report is included in the MAC-CE and includes HARQ feedback for one or more HARQ processes, and the one or more HARQ processes include the HARQ process associated with the transmission of the TB. This aspect enhances transmission efficiency by enabling aggregation of HARQ feedback for multiple processes into a single MAC-CE, reducing signaling overhead and improving resource utilization at the NE 700.

Additionally, or alternatively, the NE 700 may be configured to or operable to support where the timer is stopped based on transmission of the MAC-CE. This aspect provides clear state management for the feedback process, preventing redundant timer operations and ensuring proper synchronization between feedback transmission and timer control at the NE 700. Additionally, or alternatively, the NE 700 may be configured to or operable to support transmitting, based on incorrect reception of the transmission of the TB by a UE, second DCI that indicates transmission of a second TB and indicates the HARQ process associated with the transmission of the second TB, and receiving a second feedback report associated with the second TB on one or more resources, where the second feedback report includes a HARQ feedback error indication. This aspect enables detection and reporting of NACK-to-ACK errors, allowing the NE 700 to take corrective action and schedule appropriate retransmissions, thereby reducing data loss and improving overall transmission reliability. Additionally, or alternatively, the NE 700 may be configured to or operable to support where the feedback report includes an ID associated with the HARQ process. This aspect enables unambiguous identification of the HARQ process for which feedback is being provided, ensuring proper correlation between feedback reports and corresponding data transmissions at the NE 700.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

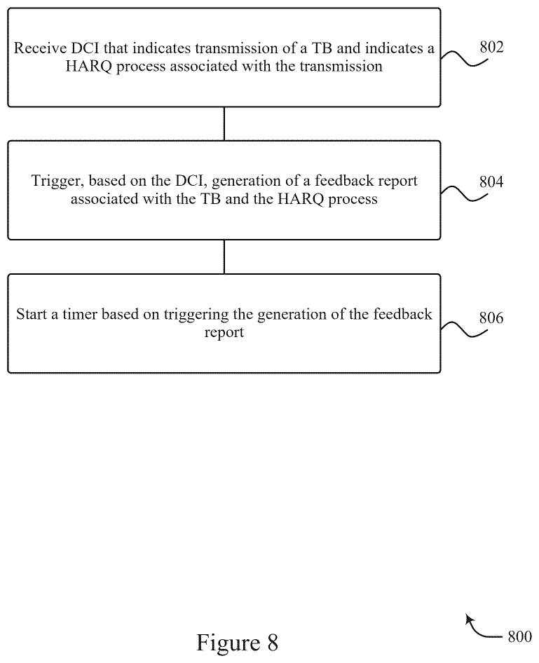

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving DCI that indicates transmission of a TB and indicates a HARQ process associated with the transmission. The operations of 802 may be performed in accordance with examples as described herein. In some implementations, aspects of the operations of 802 may be performed by a UE as described with reference to FIG. 5.

At 804, the method may include triggering, based on the DCI, generation of a feedback report associated with the TB and the HARQ process. The operations of 804 may be performed in accordance with examples as described herein. In some implementations, aspects of the operations of 804 may be performed by a UE as described with reference to FIG. 5.

At 806, the method may include starting a timer based on triggering the generation of the feedback report. The operations of 806 may be performed in accordance with examples as described herein. In some implementations, aspects of the operations of 806 may be performed a UE as described with reference to FIG. 5.

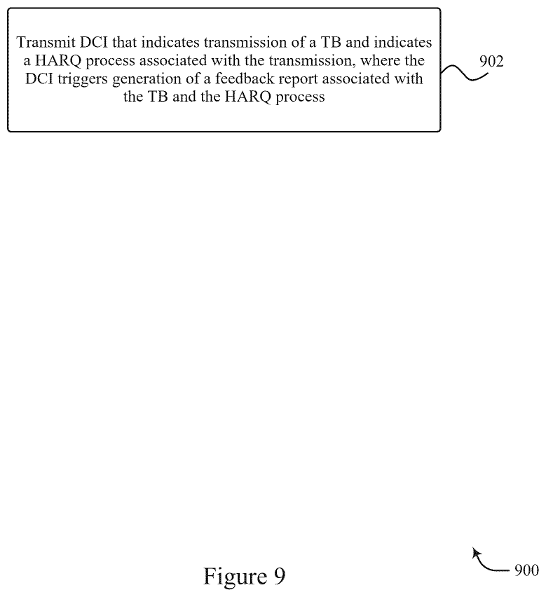

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting DCI that indicates transmission of a TB and indicates a HARQ process associated with the transmission, where the DCI triggers generation of a feedback report associated with the TB and the HARQ process. The operations of 902 may be performed in accordance with examples as described herein. In some implementations, aspects of the operations of 902 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories individually or collectively and operable to cause the UE to:
receive downlink control information (DCI) that indicates transmission of a transport block (TB) and indicates a hybrid automatic repeat request (HARQ) process associated with the transmission;
trigger, based at least in part on the DCI, generation of a feedback report associated with the TB and the HARQ process; and
start a timer based at least in part on triggering the generation of the feedback report.

2. The UE of claim 1, wherein the one or more processors are further individually or collectively operable to cause the UE to:
determine, while the timer is running that one or more resources are available for transmission of the feedback report;
generate the feedback report based at least in part on determining that the one or more resources are available; and
transmit the feedback report on the one or more resources.

3. The UE of claim 2, wherein, to generate the feedback report, the one or more processors are further individually or collectively operable to cause the UE to:
generate a medium access control (MAC) control element (MAC-CE); and
transmit the MAC-CE on the one or more resources.

4. The UE of claim 3, wherein the feedback report is included in the MAC-CE and includes HARQ feedback for one or more HARQ processes, and wherein the one or more HARQ processes include the HARQ process associated with the transmission of the TB.

5. The UE of claim 4, wherein the one or more processors are further individually or collectively operable to cause the UE to stop the timer based at least in part on transmission of the MAC-CE.

6. The UE of claim 1, wherein the one or more processors are further individually or collectively operable to cause the UE to:
receive, based at least in part on incorrect reception of the transmission of the TB, second DCI that indicates transmission of a second TB and indicates the HARQ process associated with the transmission of the second TB; and
trigger, based at least in part on the second DCI, generation of a second feedback report associated with the second TB and the HARQ process, wherein the second feedback report includes a HARQ feedback error indication.

7. The UE of claim 6, wherein the one or more processors are further individually or collectively operable to cause the UE to: start a second timer based at least in part on triggering the generation of the second feedback report.

8. The UE of claim 1, wherein the feedback report includes HARQ feedback that indicates whether the UE correctly decoded the TB.

9. The UE of claim 6, wherein the feedback report includes assistance information for scheduling subsequent downlink transmission, wherein the assistance information includes one or more of a modulation and coding scheme (MCS), a redundancy version (RV), or an amount of incremental redundancy.

10. The UE of claim 1, wherein the feedback report includes an identifier (ID) associated with the HARQ process.

11. The UE of claim 1, wherein the one or more processors are further individually or collectively operable to cause the UE to: cancel the feedback report based at least in part on an expiration of the timer.

12. A network equipment (NE) for wireless communication, comprising:
one or more memories; and
one or more processors coupled with the one or more memories individually or collectively and operable to cause the NE to:
transmit downlink control information (DCI) that indicates transmission of a transport block (TB) and indicates a hybrid automatic repeat request (HARQ) process associated with the transmission, wherein the DCI triggers generation of a feedback report associated with the TB and the HARQ process.

13. The NE of claim 12, wherein a timer is started based at least in part on the generation of the feedback report being triggered, and wherein the one or more processors are further individually or collectively operable to cause the NE to receive the feedback report associated with the TB and the HARQ process based at least in part on one or more resources being available for transmission of the feedback report while the timer is running.

14. The NE of claim 13, wherein the one or more processors are further individually or collectively operable to cause the NE to receive a medium access control (MAC) control element (MAC-CE) on the one or more resources, wherein the MAC-CE includes the feedback report.

15. The NE of claim 14, wherein the feedback report is included in the MAC-CE and includes HARQ feedback for one or more HARQ processes, and wherein the one or more HARQ processes include the HARQ process associated with the transmission of the TB.

16. The NE of claim 14, wherein the timer is stopped based at least in part on transmission of the MAC-CE.

17. The NE of claim 12, wherein the one or more processors are further individually or collectively operable to cause the NE to:
transmit, based at least in part on incorrect reception of the transmission of the TB by a user equipment (UE), second DCI that indicates transmission of a second TB and indicates the HARQ process associated with the transmission of the second TB; and
receive a second feedback report associated with the second TB on one or more resources, wherein the second feedback report includes a HARQ feedback error indication.

18. The NE of claim 12, wherein the feedback report includes an identifier (ID) associated with the HARQ process.

19. A method performed by a user equipment (UE), the method comprising:
receiving downlink control information (DCI) that indicates transmission of a transport block (TB) and indicates a hybrid automatic repeat request (HARQ) process associated with the transmission;
triggering, based at least in part on the DCI, generation of a feedback report associated with the TB and the HARQ process; and
starting a timer based at least in part on triggering the generation of the feedback report.

20. A method performed by a network equipment (NE), the method comprising:
transmitting downlink control information (DCI) that indicates transmission of a transport block (TB) and indicates a hybrid automatic repeat request (HARQ) process associated with the transmission, wherein the DCI triggers generation of a feedback report associated with the TB and the HARQ process.
